(19) United States
(12) Patent Application Publication
(10) Pub. No.: US 2018/0032245 A1
(43) Pub. Date: Feb. 1, 2018

(54) SYSTEM AND METHOD FOR VIRTUAL KEYBOARD GENERATION

(71) Applicants: NANNING FUGUI PRECISION INDUSTRIAL CO., LTD., Nanning (CN); HON HAI PRECISION INDUSTRY CO., LTD., New Taipei (TW)

(72) Inventor: CHUN-TE WU, New Taipei (TW)

(21) Appl. No.: 15/279,436

(22) Filed: Sep. 29, 2016

(30) Foreign Application Priority Data
Jul. 26, 2016 (CN) 201610593604.0

(51) Int. Cl. G06F 3/0488; G06F 3/041

(52) U.S. Cl. CPC G06F 3/04886; G06F 3/0416; G06F 2203/04104; G06T 3/60

(57) ABSTRACT

A method for virtual keyboard generation which is applied to an electronic device with a touch screen is provided in this disclosure. The method detects the touch points on the touch screen and draws shapes of the coverage of the touch points, and then identifies a palm shape and corresponding finger touch points in the shapes according to a preset butterfly-type shape. Finally the method generates a palm virtual keyboard according to the palm shape and the finger touch points, and displays the palm virtual keyboard at a position horizontally aligned with the palm shape. A palm virtual keyboard generation system is also provided.

### CROSS-REFERENCE TO RELATED APPLICATIONS

This application claims priority to Chinese Patent Application No. 201610593604.0 filed on Jul. 26, 2016, the contents of which are incorporated by reference herein.

### FIELD

The subject matter herein generally relates to virtual keyboard generation.

### BACKGROUND

Large and super large touch screen has been widely used in most electronic devices, and the size of a touch screen installed in an electronic device is big enough for operation by multiple users at the same time. As at least a palm touches on the touch screen of the electronic device, a corresponding palm virtual keyboard is generated and displayed on the touch screen with the position thereof close to and accompanying the palm and, however, can not keep a horizontal state when the palm is moving over the touch screen. Therefore, the users feel inconvenient when text input is required.

### BRIEF DESCRIPTION OF THE DRAWINGS

Implementations of the present technology will now be described, by way of example only, with reference to the attached figures, wherein:

FIG. 1 illustrates a block diagram of an embodiment of functional modules of a virtual keyboard generation system in accordance with the present disclosure.

FIG. 2 illustrates dramatic diagrams of left-hand and right hand palm sketches generated by the virtual keyboard generation system in accordance with the present disclosure.

FIG. 3A and FIG. 3B illustrate dramatic diagrams of horizontal and non-horizontal states of a left/right virtual keyboard in accordance with the present disclosure.

FIG. 4 illustrates a flowchart of a method for virtual keyboard generation in accordance with the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

References to “an” or “one” embodiment in this disclosure are not necessarily to the same embodiment, and such references mean “at least one.”

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprises”, when utilized, means “include, but not necessarily limited to”; it specifically indicates open-ended inclusion or membership in a so-described combination, group, series and the like.

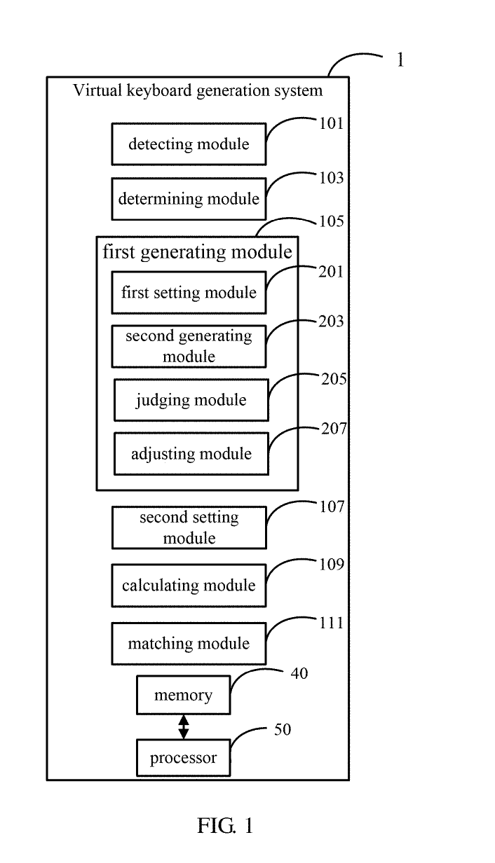

FIG. 1 illustrates a block diagram of an embodiment of functional modules of a virtual keyboard generation system in accordance with the present disclosure. The virtual keyboard generation system 1 is applied to an electronic device with a touch screen. The electronic device can be a mobile phone, a computer, a tablet or other electronic device which providing a resistance induction screen, a capacitance sensing screen, an infrared sensing screen, a surface light wave sensing screen or a surface acoustic wave sensing screen.

The virtual keyboard generation system 1 includes a detecting module 101, an identifying module 103, a first generating module 105, a second setting module 107, a calculating module 109 and a matching module 111. The first generating module 105 further includes a first setting module 201, a second generating module 203, a judging module 205 and an adjusting module 207. The modules are configured to be executed by one or more processors (the embodiment of the processor 50) to complete the invention. The modules of the disclosure are the computer programs to complete specific functions. This memory 40 stores the programs and other information of the virtual keyboard generation system 1.

The detecting module 101 detects and draws shapes of a coverage of the touch points on the touch screen the user input. And the identifying module 103 identifies the shapes detected by the detecting module 101. The shapes include palm shapes and the corresponding finger touch points, the finger touch points includes five fingers touch points, and the palm shapes includes left palm shape and right palm shape.

The first generating module 105 activates the corresponding initial template of the palm virtual keyboard according to the palm shape and the finger touch points to generate the palm virtual keyboard, and then displays the palm virtual keyboard in a appropriate location according to the palm position parameter. The palm position parameter comprises a horizontal position of the palm shape, and the positions of the finger touch points. The horizontal position of the palm shape determines the horizontal position of the palm virtual keyboard and the positions of the finger touch points determine the keys position of the palm virtual keyboard. And the first generating module 105 rebuilding the palm virtual keyboard according to the moving or rotating positions of the palm shape and the finger touch points in real time.

The second setting module 107 sets an element of the palm virtual keyboard elements as a reference element to match the left-palm virtual keyboard and the right-palm virtual keyboard, and the palm virtual keyboard elements include the finger touch points, the palm shape and the position of the palm virtual keyboard. The calculating module 109 calculates Euclidean distances from the reference element of each left-palm virtual keyboard to the reference element of each right-palm virtual keyboard respectively.

The matching module 111 classifies the Euclidean distances of the reference element from each left-palm virtual keyboard to the reference element of other right-palm virtual keyboard into a Euclidean distance group, and then match the left-palm virtual keyboard with the right-palm virtual keyboard of the minimum Euclidean distance in the Euclidean distance group.

In the embodiment of the disclosure refer to FIG. 1, the detecting module 101 detects touch points on the touch screen and draws shapes of the coverage of the touch points. The identifying module 103 identifies the palm shapes according to the preset butterfly-type shape, and the preset butterfly-type shape includes a preset left butterfly-type shape and a preset right butterfly-type shape.

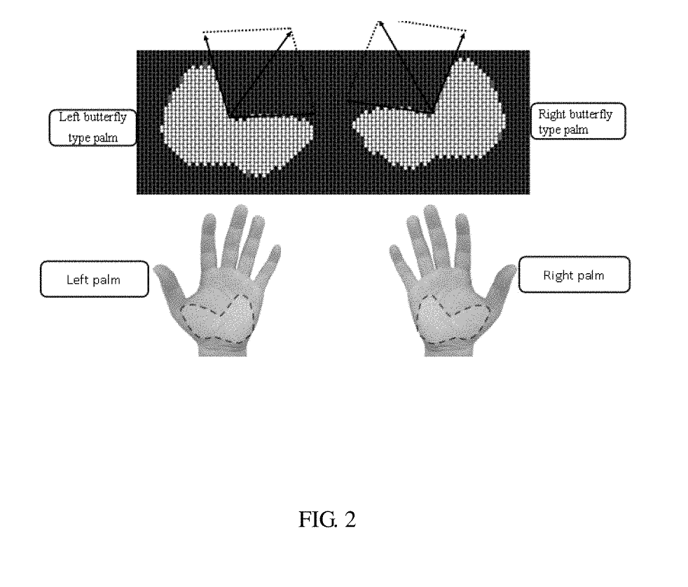

Referring to FIG. 2, the identifying module 103 presets the butterfly-type shapes upper the FIG. 2 according to the palm shapes lower the FIG. 2. And then the identifying module 103 compares the shapes of the coverage of the touch points detected by the detecting module 101 with the preset butterfly-type shape to determine the shapes of the coverage of the touch points is the palm shape according to whether a approximately value for the comparison is larger than a threshold (such as 98%). The identifying module 103 also identifies the corresponding finger touch points according to the finger touch points according to the palm shape, positions of the touch points around the palm shape and the distance between the positions.

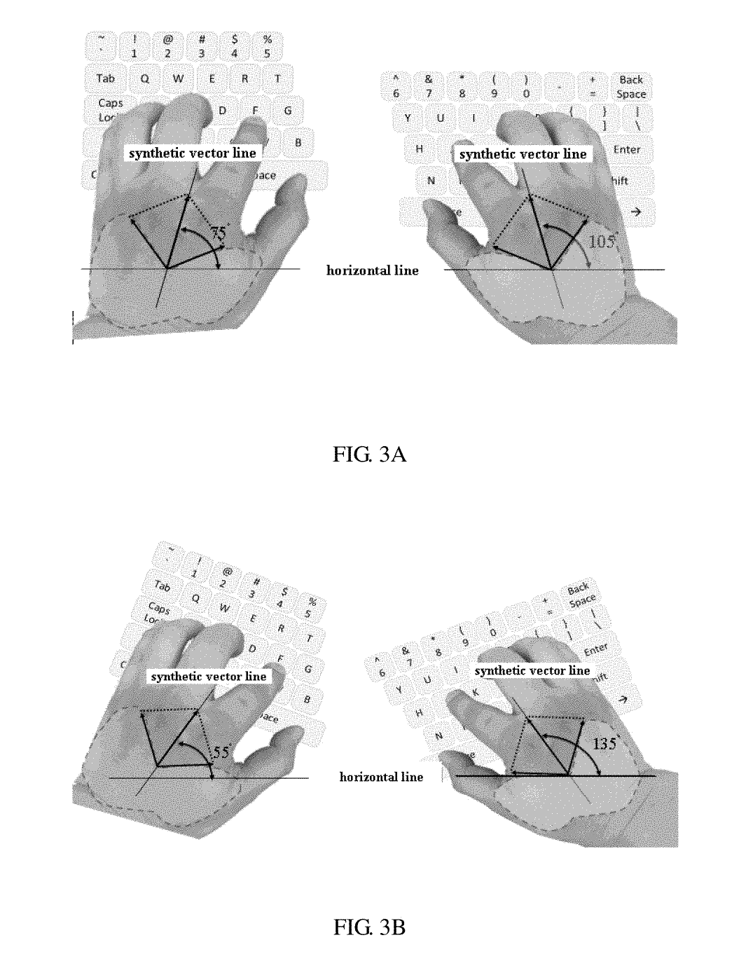

Referring to FIG. 3A, the first setting module 201 sets a connecting line of lower wave peaks of the palm shape as a horizontal line, and sets a synthetic vector line according to two lines outward from the wave troughs over the palm shape. Then the first setting module 201 sets the synthetic vector line of the left butterfly palm shape and horizontal line of the left butterfly palm shape at an included angle of 75 degrees clockwise, and sets the synthesis vector line of the right butterfly palm shape and the horizontal line of the right butterfly palm shape at an included angle of 105 degrees clockwise.

Because of the horizontal line of the palm virtual keyboard and the horizontal line of the palm shape should be kept a relative horizontal state, the horizontal line of the palm virtual keyboard is inevitably to form a preset included angle with the synthesis vector line of the butterfly-type shape, as well as the horizontal line of the palm shape. So that the first setting module 201 sets the synthetic vector line of the left butterfly palm shape and horizontal line of the left-palm virtual keyboard at an included angle of 75 degrees clockwise and sets the synthesis vector line of the right butterfly palm shape and the horizontal line of the right-palm virtual keyboard at an included angle of 105 degrees clockwise to keep the palm virtual keyboard a horizontal position.

Next, the first setting module 201 sets the key positions of the palm virtual keyboard according to the positions of the finger touch points and the horizontal position of the palm virtual keyboard. After that, the second generating module 203 generates the palm virtual keyboard according to the horizontal position of the palm virtual keyboard and the keys positions of the palm virtual keyboard.

The judging module 205 determines whether the palm shape moves or rotates in real time, and also determines whether the positions of the finger touch points change in real time. When the palm shape moves or rotates, the judging module 205 could correspondingly move or rotate the palm virtual keyboard according to the position of the palm shape and the preset included angle. And when the positions of the finger touch points change, the judging module 205 also could periodically adjusts or changes the key positions of the palm virtual keyboard according to the positions of the finger touch points.

Referring to FIG. 3B, the included angle of the synthesis vector line of the butterfly palm shape and the horizontal line changes when the palm shape is moves or rotates. In the embodiment, the judging module 205 determines the synthetic vector line of the left butterfly palm shape and the horizontal line of the left-palm virtual keyboard at an included angle of 55 degrees clockwise and the synthesis vector line of the right butterfly palm shape and the horizontal line of the right-palm virtual keyboard at an included angle of 135 degrees clockwise. Then the adjusting module 207 adjust the horizontal position of the palm virtual keyboard according to the preset included angle of the synthetic vector line of the left butterfly palm shape and the horizontal line of the left-palm virtual keyboard.

In the embodiment, the preset included angle minus the included angle of the synthesis vector line of the right butterfly palm shape and the horizontal line of the palm virtual keyboard to obtains a counterclockwise included angle to adjust the palm virtual keyboard. Therefore, the left-palm virtual keyboard is rotates 75−55=20 degrees, and the right-palm virtual keyboard rotates 105−135=−30 degrees (clockwise rotation 30 degrees) to keep the horizontal state of the left-palm virtual keyboard and the right-palm virtual keyboard. The adjusting module 207 adjusts the position of the left-palm virtual keyboard and the right-palm virtual keyboard according to the horizontal line of the left-palm virtual keyboard and the right-palm virtual keyboard, and adjusts the key positions of the left-palm virtual keyboard and the right-palm virtual keyboard according to the positions of to the positions of the left finger touch points and the right finger touch points respectively.

The second setting module 107 sets an element of the palm virtual keyboard elements as the reference element to match the left-palm virtual keyboard and the right-palm virtual keyboard. In the embodiment, the second setting module 107 sets the thumb touch point of the finger touch points as the reference element to match the left-palm virtual keyboard and the right-palm virtual keyboard. And it also can set one or more other elements of the palm virtual keyboard elements such as the palm shape or the position of the palm virtual keyboard as the reference elements to match the left-palm virtual keyboard and the right-palm virtual keyboard in the other embodiment.

After the second setting module 107 set the thumb touch point as the reference element to match the left-palm virtual keyboard and the right-palm virtual keyboard, the calculating module 109 calculates the Euclidean distances from the thumb touch points of each left-palm virtual keyboard to the thumb touch points of each right-palm virtual keyboard which identified by the identifying module 103. As shown in the following table: there are four palms touch on the touch screen, then the calculating module 109 calculates the Euclidean distances from thumb touch points of left palm 1, left palm 2, left palm 3, left palm 4 to the thumb touch points of right palm 1, right palm 2, right palm 3, right palm 4 respectively.

| | left palm 1 | left palm 2 | left palm 3 | left palm 4 |
|---|---|---|---|---|
| right palm 1 | 450 | 103 | 570 | 903 |
| right palm 2 | 350 | 320 | 679 | 72 |
| right palm 3 | 78 | 821 | 371 | 725 |
| right palm 4 | 700 | 560 | 93 | 257 |

The matching module 111 classifies the Euclidean distance of the thumb touch points from each left-palm virtual keyboard to the thumb touch points of other right-palm virtual keyboard into a Euclidean distance group and sorts them. In the embodiment, the European distances from thumb touch points of left palm 1 to the thumb touch points of right palm 1, right palm 2, right palm 3, right palm 4 from large to small in turn is: right palm 4, right palm 1, right palm 2 and right palm 3. Then the matching module 111 matches the left-palm virtual keyboard with the right-palm virtual keyboard of the minimum Euclidean distance. That is, the Euclidean distance from thumb touch points of left palm 1 to the thumb touch points of right palm 3 is the minimum one, so that the matching module 111 matches the left-palm virtual keyboard of left palm 1 with the right-palm virtual keyboard right palm 3.

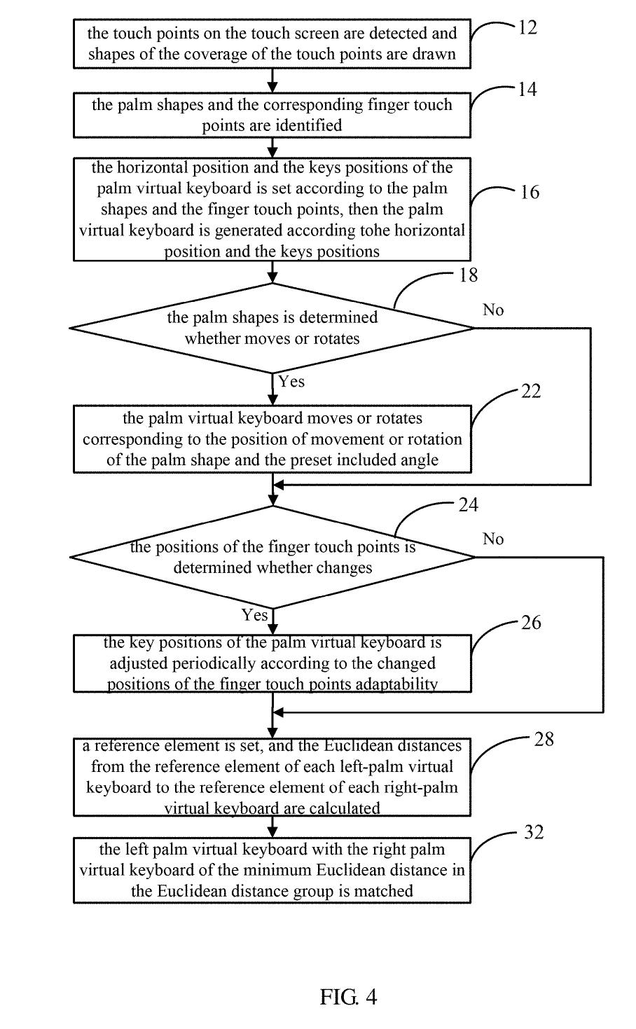

FIG. 4 illustrates a flowchart of a method for virtual keyboard generation in accordance with the present disclosure, and the method for virtual keyboard generation is applied to an electronic device with a touch screen. The steps of the method for virtual keyboard generation described as following.

At block 12, the touch points on the touch screen are detected and shapes of the coverage of the touch points are drawn.

At block 14, the shapes of the coverage of the touch points are compared with the preset butterfly-type palm shapes. And the shapes are identified as palm shapes when the approximately value for the comparison of the shapes of the coverage of the touch points and the preset butterfly-type palm shape is larger than a threshold. Then the corresponding finger touch points are identified according to the palm shapes, the positions of the touch points around the palm shapes and distances between the positions, wherein the finger touch points include five finger touch points and the palm shapes include the left palm shape and the right palm shape.

At block 16, a connecting line of lower wave peaks of the palm shape is set as a horizontal line, and a synthetic vector line is set according to two lines outward from the wave troughs over the palm shape, and then an included angle of the horizontal line of the palm shape and the synthetic vector line is preset. Because of a relative horizontal state should be kept between the palm virtual keyboard and the palm shape, so that an included angle of the horizontal line of the palm virtual keyboard and the synthetic vector line is preset as well as the included angle of the horizontal line of the palm shape and the synthetic vector line.

Next, the horizontal position of the palm virtual keyboard is set according to the included angle of the horizontal line of the palm virtual keyboard and the synthetic vector line, and the keys positions of the palm virtual keyboard is set according to the horizontal position of the palm virtual keyboard and the positions of the finger touch points. Finally, the palm virtual keyboard is generated according to the horizontal position of the palm virtual keyboard and the keys positions of the palm virtual keyboard.

At block 18, the palm shapes is determined whether moves or rotates. If the palm shapes moves or rotates, it jumps to block 22, otherwise jumps to block 24.

At block 22, the palm virtual keyboard moves or rotates corresponding to the position of movement or rotation of the palm shape and the preset included angle.

At block 24, the positions of the finger touch points is determined whether change. If the positions of the finger touch points change, it jumps to block 26, otherwise jumps to block 28.

At block 26, the key positions of the palm virtual keyboard is adjusted periodically according to the changed positions of the finger touch points adaptability.

At block 28, an element of the palm virtual keyboard elements is set as a reference element, and Euclidean distances from the reference element of each left-palm virtual keyboard to the reference element of each right-palm virtual keyboard are calculated respectively.

At block 32, the Euclidean distances of the reference element from each left-palm virtual keyboard to the reference element of other right-palm virtual keyboard are classified into Euclidean distance group, and the left-palm virtual keyboard with the right-palm virtual keyboard of the minimum Euclidean distance in the Euclidean distance group is matched.

The detailed description above is the introduction of the present disclosure of a system and method for virtual keyboard generation. Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A method for virtual keyboard generation, applied to an electronic device with a touch screen, comprising:
detecting touch points on the touch screen and drawing shapes of a coverage of the touch points;
identifying a palm shape and corresponding finger touch points in the shapes according to a preset butterfly-type palm shape; and
generating a palm virtual keyboard according to the palm shape and the finger touch points and displaying the palm virtual keyboard at a position horizontally aligned with the palm shape.

2. The method as claimed in claim 1, wherein the identifying step further comprises:
comparing the shapes of the coverage of the touch points with the preset butterfly-type palm shape to determine whether the shapes of the coverage of the touch points is the palm shape according to whether a approximately value for the comparison is larger than a threshold; and
identifying the finger touch points according to the palm shape, positions of the touch points around the palm shape and distances between the positions.

3. The method as claimed in claim 1, wherein the step of displaying the virtual palm keyboard further comprises:
setting a horizontal position of the palm virtual keyboard according to a horizontal line of the palm shape;
setting keys positions of the palm virtual keyboard according to the horizontal position of the palm virtual keyboard and positions of the finger touch points; and
generating the palm virtual keyboard according to the horizontal position of the palm virtual keyboard and the keys positions of the palm virtual keyboard.

4. The method as claimed in claim 3, wherein the step of setting the horizontal position of the palm virtual keyboard further comprises:
setting a connecting line of lower wave peaks of the palm shape as a horizontal line and setting a synthetic vector line according to two lines outward from the wave troughs over the palm shape; and
generating a preset included angle according to the horizontal line of the palm virtual keyboard and the synthetic vector line to keep a relative horizontal state between the palm virtual keyboard and the palm shape.

5. The method as claimed in claim 3, wherein the step of displaying the virtual palm keyboard further comprises:
determining whether the palm shape moves or rotates;
when the palm shape moves or rotates, correspondingly moving or rotating the palm virtual keyboard according to the position of the palm shape and the preset included angle;
determining whether the positions of the finger touch points change; and
when the positions of the finger touch points change, periodically adjusting or changing the key positions of the palm virtual keyboard according to the positions of the finger touch points.

6. The method as claimed in claim 1, wherein the palm virtual keyboard includes a left-palm virtual keyboard and a right-palm virtual keyboard, further comprising:
setting an element of the palm virtual keyboard elements as a reference element for matching the left-palm virtual keyboard with the right-palm virtual keyboard;
calculating Euclidean distances from the reference element of each left-palm virtual keyboard to the reference element of each right-palm virtual keyboard respectively;
classifying the Euclidean distances of the reference element from each left-palm virtual keyboard to the reference element of other right-palm virtual keyboard into a Euclidean distance group;
matching the left-palm virtual keyboard with the right-palm virtual keyboard of the minimum Euclidean distance in the Euclidean distance group.

7. The method as claimed in claim 6, wherein the palm virtual keyboard elements comprises the finger touch points, the palm shape and the position of the palm virtual keyboard.

8. A virtual keyboard generation system applied to an electronic device with a touch screen which has a touch screen, the virtual keyboard generation system comprising:
at least one processor;
a non-transitory storage system coupled to the at least one processor and configured to store one or more programs that are executed by the at least one processor, the one or more programs including instructions for:
detecting touch points on the touch screen and drawing shapes of a coverage of the touch points;
identifying a palm shape and corresponding finger touch points in the shapes according to a preset butterfly-type shape; and
generating a palm virtual keyboard according to the palm shape and the finger touch points and displaying the palm virtual keyboard at a position horizontally aligned with the palm shape.

9. The system as claimed in claim 8, wherein the one or more programs further include instructions for:
comparing the shapes of the coverage of the touch points with the preset butterfly-type palm shape to determine whether the shapes of the coverage of the touch points is the palm shape according to whether a approximately value for the comparison is larger than a threshold; and
identifying the finger touch points according to the palm shape, positions of the touch points around the palm shape and distances between the positions.

10. The system as claimed in claim 8, wherein the one or more programs further include instructions for:
setting a horizontal position of the palm virtual keyboard according to a horizontal line of the palm shape;
setting keys positions of the palm virtual keyboard according to the horizontal position of the palm virtual keyboard and positions of the finger touch points; and
generating the palm virtual keyboard according to the horizontal position of the palm virtual keyboard and the keys positions of the palm virtual keyboard.

11. The system as claimed in claim 10, wherein the one or more programs further include instructions for:
setting a connecting line of lower wave peaks of the palm shape as a horizontal line and setting a synthetic vector line according to two lines outward from the wave troughs over the palm shape; and
generating a preset included angle according to the horizontal line of the palm virtual keyboard and the synthetic vector line to keep a relative horizontal state between the palm virtual keyboard and the palm shape.

12. The system as claimed in claim 10, wherein the one or more programs further include instructions for:
determining whether the palm shape is moves or rotates;
when the palm shape moves or rotates, correspondingly moving or rotating the palm virtual keyboard according to the position of the palm shape and the preset included angle;
determining whether the positions of the finger touch points is change; and
when the positions of the finger touch points change, periodically adjusting or changing the key positions of the palm virtual keyboard according to the positions of the finger touch points.

13. The system as claimed in claim 8, wherein the palm virtual keyboard includes the left-palm virtual keyboard and the right-palm virtual keyboard, and the one or more programs further include instructions for:
setting an element of the palm virtual keyboard elements as a reference element for matching the left-palm virtual keyboard with the right-palm virtual keyboard;
calculating Euclidean distances from the reference element of each left-palm virtual keyboard to the reference element of each right-palm virtual keyboard respectively;
classifying the Euclidean distances of the reference element from each left-palm virtual keyboard to the reference element of other right-palm virtual keyboard into a Euclidean distance group;
matching the left-palm virtual keyboard with the right-palm virtual keyboard of the minimum Euclidean distance in the Euclidean distance group.

14. The system as claimed in claim 13, wherein the palm virtual keyboard elements comprises the finger touch points, the palm shape and the position of the palm virtual keyboard.
